(19) United States
(12) Patent Application Publication
(10) Pub. No.: US 2019/0246428 A1
(43) Pub. Date: Aug. 8, 2019

(54) ELECTRONIC DEVICE, AND WIRELESS COMMUNICATION METHOD OF ELECTRONIC DEVICE

(71) Applicant: Samsung Electronics Co., Ltd., Suwon-si, Gyeonggi-do (KR)

(72) Inventors: Su-Ha YOON, Seoul (KR); Sung-Chul PARK, Seoul (KR); Eui-Chang JUNG, Seoul (KR); Soo-Jin PARK, Suwon-si (KR)

(21) Appl. No.: 16/339,610

(22) PCT Filed: Sep. 27, 2017
(86) PCT No.: PCT/KR2017/010740

§ 371 Date: Apr. 4, 2019

(30) Foreign Application Priority Data
Oct. 6, 2016 (KR) 10-2016-0129361

(51) Int. Cl. H04W 74/08; H04W 16/14; H04W 74/00

(52) U.S. Cl. CPC H04W 74/0808; H04W 84/042; H04W 74/006; H04W 16/14

(57) ABSTRACT

Various embodiments of the present invention relate to an electronic device and a wireless communication method of the electronic device, wherein the electronic device comprises a transmission/reception device for transmitting and receiving data using an unlicensed band and a processor for controlling operations of the transmission/reception device, wherein the processor may control so as to request a wireless resource for uplink transmission in the un-licensed band to the base station, to obtain the wireless resource in response to the request, and to perform uplink transmission in the un-licensed band using the wireless resource.

### CROSS-REFERENCE TO RELATED APPLICATION(S)

This application is a U.S. National Stage application under 35 U.S.C. § 371 of an International application number PCT/KR2017/010740, filed on Sep. 27, 2017, which is based on and claimed priority of a Korean patent application number 10-2016-0129361, filed on Oct. 6, 2016, in the Korean Intellectual Property Office, the disclosure of which is incorporated by reference herein in its entirety.

### TECHNICAL FIELD

The disclosure generally relates to an electronic device in a wireless communication system and a wireless communication method by the electronic device.

### BACKGROUND ART

In general, one or more cells may exist in one evolved Node B (eNB) of a wireless communication system, and the eNB may perform wireless communication with User Equipments (UEs) through different carriers in different cells. The eNB may transmit and receive data to and from a plurality of electronic devices.

The eNB may communicate with a plurality of electronic devices through existing carriers. The eNB may transmit and receive data to and from electronic devices through a downlink or an uplink transmission service. The eNB may inform the electronic device of resources that can be used by the corresponding electronic device by transmitting uplink scheduling information to the corresponding electronic device. Accordingly, the corresponding electronic device may perform uplink transmission to the eNB on the basis of the received uplink scheduling information.

### DETAILED DESCRIPTION OF THE INVENTION

### Technical Problem

In response to the recent explosive increase in mobile traffic, a method of performing wireless communication using an unlicensed band has been developed. A wireless communication system using an unlicensed band in which not only downlink transmission but also uplink transmission is possible requires structural changes. Unlike a method of paying an expensive usage fee in order to use an exclusive frequency, the use of an unlicensed band corresponds to a method that does not require that the right to use a frequency be secured, and thus may expand the capacity of wireless communication at low cost.

Due to transmission by another electronic device, a particular electronic device may fail in uplink transmission.

Accordingly, embodiments of the disclosure may provide an electronic device and a wireless communication method of an electronic device for efficiently performing uplink transmission by a plurality of electronic devices present in an unlicensed band cell.

### Technical Solution

An electronic device according to one of various embodiments to solve the aforementioned problems or other problems includes: a transmission/reception device configured to transmit and receive data; and a processor configured to control the transmission/reception device, wherein the processor performs control to transmit a random-access preamble to an evolved Node B (eNB) in an unlicensed band, acquires Timing Advance (TA) information in response to the random-access preamble, and control the acquired TA information to perform uplink transmission.

An electronic device according to one of various embodiments includes: a filter; a transmission/reception device configured to transmit and receive data; and a processor configured to control the transmission/reception device, wherein the processor receives an uplink grant from an evolved Node B (eNB) and controls the filter, based on the uplink grant.

A wireless communication method of an electronic device according to one of various embodiments includes: transmitting a random-access preamble to an evolved Node B (eNB) in an unlicensed band; acquiring Timing Advance (TA) information in response to the random-access preamble; and transmitting the uplink data by controlling the acquired TA information.

Another wireless communication method of an electronic device performing wireless data communication with an access point according to one of various embodiments includes: receiving an uplink grant from an evolved Node B (eNB); and controlling a filter included in a reception device of the electronic device, based on the uplink grant.

### Advantageous Effects

According to an electronic device and a wireless communication method of an electronic device according to various embodiments, the electronic device can perform uplink transmission in an unlicensed band by correcting a TAV value, using information on grouping of a plurality of electronic devices on the basis of the corrected TA value or timing information, or cutting a sequence region of the preamble corresponding to a duration time, which is a waiting time for a random-access request, and attaching the cut sequence area to the last region of the preamble to be transmitted. Further, the electronic device may perform a preparation operation (for example, LBT) for uplink data transmission only in scheduled resources (frequency band). Accordingly, when performing the preparation for uplink data transmission, it is possible to prevent the electronic device according to various embodiments from being interrupted by other electronic devices.

### BRIEF DESCRIPTION OF DRAWINGS

FIG. 1 illustrates a network environment according to various embodiments of the disclosure;

FIG. 2 illustrates an example of the configuration of a wireless communication network according to various embodiments of the disclosure;

FIG. 3 illustrates an example of the configuration of an electronic device and an eNB according to various embodiments of the disclosure;

FIG. 4 illustrates an operation process of the electronic device according to various embodiments of the disclosure;

FIG. 5 illustrates an operation process of the electronic device and the eNB according to various embodiments of the disclosure;

FIG. 6 illustrates an example of transmission of a RACH random-access preamble by the electronic device according to various embodiments of the disclosure;

FIG. 7 illustrates an operation procedure of the electronic device according to various embodiments of the disclosure;

FIG. 8 illustrates grouping of electronic devices in a wireless communication system according to various embodiments of the disclosure;

FIG. 9 illustrates an operation procedure of the electronic device and the eNB according to various embodiments of the disclosure;

FIG. 10 illustrates preambles grouped according to each LBT duration time according to various embodiments of the disclosure;

FIG. 11 illustrates a modulation scheme in a reception device of the electronic device according to various embodiments of the disclosure;

FIG. 12 illustrates an example of the configuration of the electronic device according to various embodiments of the disclosure;

FIGS. 13A and 13B illustrate examples of the configuration of a filter included in the reception device of the electronic device according to various embodiments of the disclosure;

FIGS. 14 to 16 illustrate examples of the configuration of the electronic device according to various embodiments of the disclosure;

FIG. 17 is a block diagram illustrating the electronic device according to various embodiments; and

FIG. 18 is a block diagram illustrating a program module according to various embodiments.

### MODE FOR CARRYING OUT THE INVENTION

Hereinafter, various embodiments of the disclosure will be described with reference to the accompanying drawings. The embodiments and the terms used therein are not intended to limit the technology disclosed herein to specific forms, and should be understood to include various modifications, equivalents, and/or alternatives to the corresponding embodiments. In describing the drawings, similar reference numerals may be used to designate similar constituent elements. A singular expression may include a plural expression unless they are definitely different in a context. As used herein, the expression “A or B” or “at least one of A and/or B” may include all possible combinations of items enumerated together. The expression “a first”, “a second”, “the first”, or “the second” may modify various components regardless of the order and/or the importance, and is used merely to distinguish one element from any other element without limiting the corresponding elements. When an element (e.g., first element) is referred to as being “(functionally or communicatively) connected,” or “directly coupled” to another element (second element), the element may be connected directly to the another element or connected to the another element through yet another element (e.g., third element).

The expression “configured to” as used in various embodiments of the disclosure may be interchangeably used with, for example, “suitable for”, “having the capacity to”, “designed to”, “adapted to”, “made to”, or “capable of” in terms of hardware or software, according to circumstances. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., Central Processing Unit (CPU) or Application Processor (AP)) that can perform the corresponding operations by executing one or more software programs stored in a memory device.

An electronic device according to various embodiments of the disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, or a wearable device. According to various embodiments, the wearable device may include at least one of an accessory type (e.g., a watch, a ring, a bracelet, an anklet, a necklace, a pair of glasses, a contact lens, or a Head-Mounted Device (HMD)), a fabric or clothing integrated type (e.g., an electronic piece of clothing), a body-mounted type (e.g., a skin pad or tattoo), or a bio-implantable type (e.g., an implantable circuit). In some embodiments, the electronic device may include at least one of, for example, a television, a Digital Video Disk (DVD) player, an audio player, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, or an electronic photo frame.

In other embodiments, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Device, electronic devices for a ship (e.g., a navigation device for a ship, and a gyro-compass), avionics, security devices, an automotive head unit, a robot for home or industry, an Automatic Teller's Machine (ATM) in banks, Point Of Sales (POS) in a shop, or internet device of things (e.g., a light bulb, various sensors, electric or gas meter, a sprinkler device, a fire alarm, a thermostat, a streetlamp, a toaster, sporting goods, a hot water tank, a heater, a boiler, etc.). According to some embodiments, an electronic device may include at least one of a part of furniture or a building/structure, an electronic board, an electronic signature receiving device, a projector, and various types of measuring instruments (e.g., a water meter, an electric meter, a gas meter, a radio wave meter, and the like). In various embodiments, the electronic device may be flexible, or may be a combination of one or more of the aforementioned various devices. The electronic device according to embodiments of the disclosure is not limited to the above-described devices. In the disclosure, the term “user” may indicate a person using an electronic device or a device (e.g., an artificial intelligence electronic device) using an electronic device.

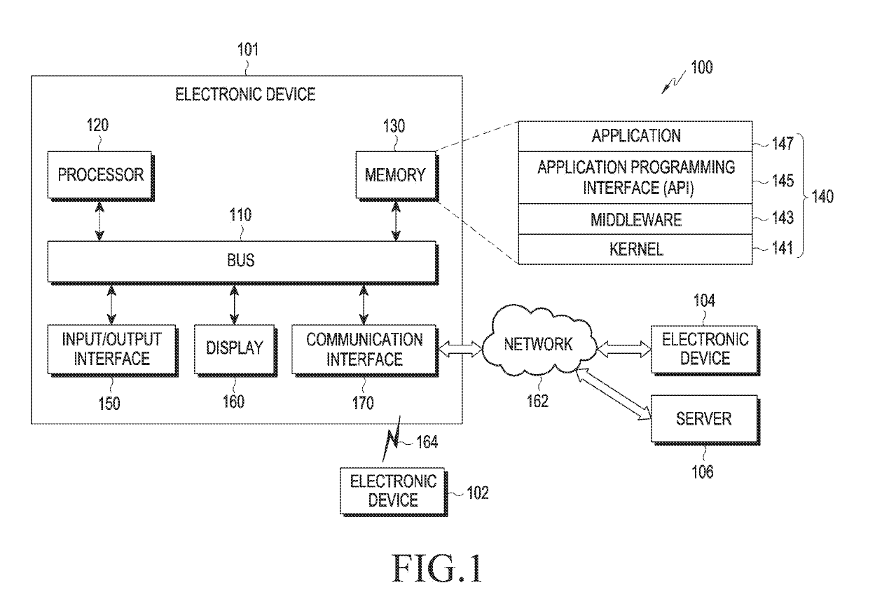

Referring to FIG. 1, an electronic device 101 within a network environment 100 according to various embodiments will be described. The electronic device 101 may include a bus 110, a processor 120, a memory 130, an input/output interface 150, a display 160, and a communication interface 170. In some embodiments, the electronic device 101 may omit at least one of the elements, or may further include other elements. The bus 110 may include, for example, a circuit that interconnects the elements 110 to 170 and transmits communication (for example, control messages or data) between the elements. The processor 120 may include one or more of a central processing unit, an application processor, and a communication processor (CP). The processor 120, for example, may carry out operations or data processing relating to the control and/or communication of at least one other element of the electronic device 101.

The memory 130 may include volatile and/or non-volatile memory. The memory 130 may store, for example, instructions or data relevant to at least one other element of the electronic device 101. According to an embodiment, the memory 130 may store software and/or a program 140. The program 140 may include, for example, a kernel 141, middleware 143, an application programming interface (API) 145, and/or application programs (or “applications”) 147. At least some of the kernel 141, the middleware 143, or the API 145 may be referred to as an operating system. The kernel 141 may control or manage system resources (for example, the bus 110, the processor 120, or the memory 130) used for executing an operation or function implemented by other programs (for example, the middleware 143, the API 145, or the application 147). Furthermore, the kernel 141 may provide an interface through which the middleware 143, the API 145, or the application programs 147 may access the individual elements of the electronic device 101 to control or manage the system resources.

The middleware 143 may function as, for example, an intermediary for allowing the API 145 or the application programs 147 to communicate with the kernel 141 to exchange data. Furthermore, the middleware 143 may process one or more task requests, which are received from the application programs 147, according to priorities thereof. For example, the middleware 143 may assign priorities for using the system resources (for example, the bus 110, the processor 120, the memory 130, or the like) of the electronic device 101 to one or more of the application programs 147, and may process the one or more task requests. The API 145 is an interface through which the applications 147 control functions provided from the kernel 141 or the middleware 143, and may include, for example, at least one interface or function (for example, instruction) for file control, window control, image processing, or text control. For example, the input/output interface 150 may forward instructions or data, input from a user or an external device, to the other element(s) of the electronic device 101, or may output instructions or data, received from the other element(s) of the electronic device 101, to the user or the external device.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160 may display, for example, various types of content (for example, text, images, videos, icons, and/or symbols) for a user. The display 160 may include a touch screen and may receive, for example, a touch, gesture, proximity, or hovering input using an electronic pen or the user's body part. The communication interface 170 may establish, for example, communication between the electronic device 101 and an external device (for example, a first external electronic device 102, a second external electronic device 104, or a server 106). For example, the communication interface 170 may be connected to a network 162 through wireless or wired communication to communicate with the external device (for example, the second external electronic device 104 or the server 106).

The wireless communication may include, for example, a cellular communication that uses at least one of LTE, LTE-Advance (LTE-A), code division multiple access (CDMA), wideband CDMA (WCDMA), universal mobile telecommunications system (UNITS), wireless broadband (WiBro), global system for mobile communications (GSM), or the like. According to an embodiment, the wireless communication may include, for example, at least one of Wi-Fi (Wireless Fidelity), Bluetooth, Bluetooth low energy (BLE), ZigBee, near field communication (NFC), magnetic secure transmission, Radio Frequency (RF), or body area network (BAN). According to an embodiment, the wired communication may include GNSS. The GNSS may be, for example, a global positioning system (GPS), a global navigation satellite system (Glonass), a Beidou navigation satellite system (hereinafter, referred to as “Beidou”), or Galileo (the European global satellite-based navigation system). Hereinafter, in this document, the term “GPS” may be interchangeable with the term “GNSS”. The wired communication may include, for example, at least one of a Universal Serial Bus (USB), a High Definition Multimedia Interface (HDMI), Recommended Standard 232 (RS-232), power line communication, a Plain Old Telephone Service (POTS), or the like. The network 162 may include a telecommunications network, for example, at least one of a computer network (for example, a LAN or a WAN), the Internet, or a telephone network.

Each of the first and second external electronic devices 102 and 104 may be of the same or a different type from the electronic device 101. According to various embodiments, all or some of the operations executed in the electronic device 101 may be executed in another electronic device or a plurality of electronic devices (for example, the electronic devices 102 and 104 or the server 106). According to an embodiment, when the electronic device 101 has to perform some functions or services automatically or in response to a request, the electronic device 101 may make a request for performing at least some functions relating thereto to another device (for example, the electronic device 102 or 104 or the server 106) instead of performing the functions or services by itself or in addition. Another electronic device (for example, the electronic device 102 or 104, or the server 106) may execute the requested functions or the additional functions, and may deliver a result thereof to the electronic device 101. The electronic device 101 may provide the received result as it is, or may additionally process the received result to provide the requested functions or services. To this end, for example, cloud computing, distributed computing, or client-server computing technology may be used.

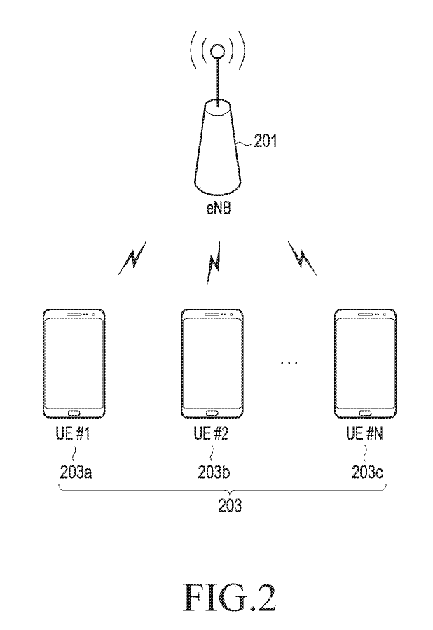

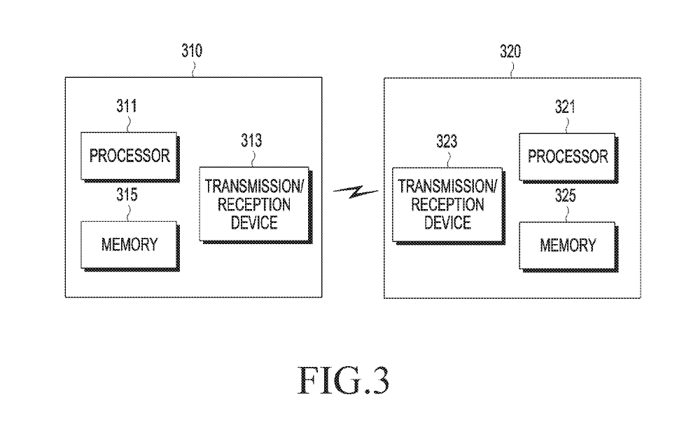

FIG. 2 illustrates an example of a wireless communication system according to various embodiments of the disclosure, and FIG. 3 illustrates an example of the configuration of an electronic device according to various embodiments of the disclosure.

Referring to FIG. 2, according to various embodiments of the disclosure, a wireless communication system may include an eNB 201 connected to a network and a plurality of electronic devices 203 (203a, 203b, and 203c) existing in a plurality of cell areas of the eNB 201.

The eNB 201 may provide service in a plurality of cells having different bandwidths (for example, frequency widths) and provide a downlink transmission and an uplink transmission service to a plurality of electronic devices. Further, the eNB 201 may provide service in a plurality of cells having different carriers and provide downlink transmission and uplink transmission service to a plurality of electronic devices. According to various embodiments, the eNB 201 may implement and operate Carrier Aggregation (CA) operation, in which a licensed band is used as a first cell (for example, primary cell (Pcell)) and an unlicensed band is used as a second cell (for example, secondary cell (Scell)), an environment in which an unlicensed band is used as a small cell and Dual Connectivity (DC).

The eNB 201 may use an unlicensed band (for example, 5 GHz) to increase capacity and may provide not only downlink transmission but also uplink transmission service to a plurality of electronic devices in the unlicensed band cell (sCell). The electronic device 203 may transmit data to the eNB 201 through radio resources, for example, a RACH allocated for RACH transmission in the unlicensed band (for example, 5 GHz).

According to various embodiments of the disclosure, each of the plurality of electronic devices 203 existing in the unlicensed band cell (sCell) may make a request for radio resources to the eNB 201. Accordingly, the eNB 201 may perform a scheduling operation for communication using the unlicensed band with the plurality of electronic devices 203 and process the request for radio resources from the plurality of electronic devices 203 according to scheduling. According to various embodiments of the disclosure, the plurality of electronic devices 203 may perform a Listen-Before-Talk (LBT) operation for determining whether channel access/occupation/use are possible for uplink transmission in the unlicensed band as an operation for identifying whether another electronic device occupies or uses the allocated resources, that is, a preparation operation for the uplink transmission service. According to the preparation operation, the electronic device 203 may perform uplink transmission using the resources without any collision with another device. According to various embodiments, when the particular electronic device 203a performs the preparation operation, and at that time it is determined that allocated resources are occupied or used, the particular electronic device 203a may not perform uplink transmission. The LBT operation is an operation for identifying whether allocated resources (for example, a combination of a plurality of subcarriers) are used by another system or another UE through the allocated resources before transmitting data, and may be performed by an energy detection device or operation in the allocated resources.

According to various embodiments of the disclosure, the plurality of electronic devices 203 existing in the unlicensed band cell may be located at different distances from the eNB 201, have their own Timing Advance (TA) values for uplink transmission synchronization according to the distances, and perform uplink transmission according to the TA values thereof. According to various embodiments, the eNB 203 may configure the electronic device located far from the eNB 201 among the electronic devices 203 located within the cell to initiate transmission relatively early according to the TA and the electronic device located close to the eNB to initiate transmission relatively late according to the TA so as to maintain time points at which uplink signals are received to be the same on the side of the eNB 203. Referring to FIG. 3, an electronic device 310 (for example, the same as or similar to the electronic device 101 of FIG. 1 or the electronic device 203 of FIG. 2) may include a processor 311, a transmission/reception device 313, and a memory 315.

According to various embodiments of the disclosure, the processor 311 (for example, the same as or similar to the processor 120 of FIG. 1) of the electronic device 310 may process information according to the operation of the electronic device 310 or information according to execution of a program, an application, or a function. The processor 311 may control the operation of the transmission/reception device 313.

According to various embodiments of the disclosure, the processor 311 may control the operation of wireless communication with the eNB 320 and control the operation for uplink transmission in the unlicensed band. According to various embodiments, the processor 311 may control a random-access operation for access to the eNB 320. The processor 311 may control transmission of a random-access preamble message to the eNB 320 and reception of a random-access response message in response to the random-access preamble message. The random-access response message may include timing information (for example, a timing advance (TA) value) for uplink synchronization set according to the distance from the electronic device in a second cell (for example, SCell) for uplink timing reference. The processor 311 may control timing for uplink transmission, that is, correct the timing information (TA value) received from the eNB 310 on the basis of the timing information (TA value) acquired through the response message and the duration of the LBT operation that the electronic device 310 can identify. The correction (TA value) of the timing information may be calculated using Equation (1).

TA correction value=received TA value−(RACH preamble transmission start time−RACH resource starting boundary) [Equation 1]

The processor 311 may control the transmission/reception device 313 to transmit the corrected TA value to the eNB 320 and synchronize transmission timing with the eNB 310 on the basis of the corrected TA value.

According to various embodiments, the processor 311 may perform control to complete access through a contention resolution process after preamble transmission and response reception.

According to various embodiments, the processor 311 may control the transmission/reception device 313 to receive a preamble allocated by the eNB 320. The preamble may be allocated to the electronic device 310 in a licensed band cell operated by the eNB 320 and an unlicensed band cell operated by the eNB 320.

According to various embodiments of the disclosure, the processor 311 may transmit, to the eNB, a random-access preamble message including a preamble obtained by cutting sequences 701 located in a start region 711 of the front preamble corresponding to the LBT duration time from the allocated preamble and adding the cut sequences to a last region 713 of the preamble. The eNB receiving the preamble message may be made aware of the time at which the electronic device 310 performs the LBT operation through the preamble message and may infer a distance between the eNB and the electronic device.

According to various embodiments of the disclosure, a RACH preamble may be configured according to the LBT duration time, as illustrated in FIG. 10. The electronic device may select a preamble to be transmitted from preambles separated for each LBT duration time 1001, 1003, 1005, or 1007 according to the LBT duration time and transmit the selected preamble.

According to various embodiments, the processor 410 is a hardware module or a software module (for example, an application) and may be a hardware element (function) or a software element (program) including at least one of various sensors included in the electronic device 310, a data measurement module, an input/output interface, a module for managing a state or an environment of the electronic device 310, or a communication module.

According to various embodiments of the disclosure, the transmission/reception device 313 of the electronic device 310 is a communication module (for example, the communication interface 170 of FIG. 1), and may communicate with the eNB 320 (for example, the eNB 201 or 320 of FIG. 2) or another electronic device (for example, the electronic device 102 or 104, or the server 106 of FIG. 1) on a wireless communication network under the control of the processor 311. According to various embodiments of the disclosure, the communication module may transmit and receive data related to the operation executed under the control of the processor 311 to and from the eNB 320 or another electronic device. The communication module may be connected to a network using wireless communication or wired communication via a communication interface, or may perform communication through device-to-device connection. The wireless communication may include at least one of, for example, Wireless Fidelity (Wi-Fi), Bluetooth (BT), ZigBee, Z-Wave, Near Field Communication (NFC), Global Positioning System (GPS), or cellular communication (for example, at least one of LTE, LTE-A, CDMA, WCDMA, UMTS, WiBro, or GSM). The wired communication may include at least one of, for example, a Universal Serial Bus (USB), a High-Definition Multimedia Interface (HDMI), Recommended Standard 232 (RS-232), a Plain Old Telephone Service (POTS), a Universal Asynchronous Receiver Transmitter (UART), an Inter-Integrated Circuit (I2C), a Serial Peripheral Interface (SPI), or a Controller Area Network (CAN). The communication module may include all types of communication schemes that have been widely known or are to be developed in the future, as well as the aforementioned communication schemes.

According to various embodiments of the disclosure, the memory 315 (for example, the memory 130 of FIG. 1) of the electronic device 310 may temporarily store a program required for the functional operation according to various embodiments and various pieces of data generated during execution of the program. The memory 315 may broadly include a program area and a data area. The program area may store information related to driving of the electronic device 310, such as an Operating System (OS) for booting the electronic device 310. The data area may store transmitted/received data and generated data according to various embodiments. Further, the memory 315 may include at least one storage medium of a flash memory, a hard disk, a multimedia card micro-type memory (for example, an SD or XD memory), RAM, and ROM. According to various embodiments, the memory 315 may store information for communication with the eNB 320 or another electronic device and transmitted/received data.

As described above, various embodiments of the disclosure have described main elements of the electronic device 310 through the electronic device 310 of FIG. 3. However, in various embodiments of the disclosure, not all of the elements illustrated in FIG. 3 are necessary elements, and the electronic device may be implemented through a larger number of elements or a smaller number of elements than the illustrated elements. Further, the locations of the main elements of the electronic device 310 described through FIG. 3 may be changed according to various embodiments.

Referring back to FIG. 3, according to various embodiments of the disclosure, the eNB 320 (for example, the same as or similar to the eNB 302 of FIG. 2) may include a processor 321, a transmission/reception device 323, and a memory 325.

According to various embodiments of the disclosure, the processor 321 of the eNB 320 may process information according to the operation of the eNB 320 or information according to execution of a program, an application, or a function. The processor 321 may control the operation of the transmission/reception device 323 for communication with the electronic device 310 and control the operation related to uplink transmission and the operation related to downlink transmission.

The processor 321 may perform control to transmit a random-access preamble assignment message for preamble assignment to the electronic device 310.

The processor 321 may perform control to receive a random-access preamble message transmitted from the electronic device 310 receiving the random-access preamble assignment message. The processor 321 may perform control to transmit a random-access response message to the electronic device 310 in response to the received random-access preamble message. The random-access response message may include timing information (for example, a timing advance (TA) value) set according to the distance from the electronic device 310 in a second cell (for example, SCell) for uplink timing reference.

The processor 321 may perform control to allocate radio resources for uplink transmission of the electronic device 310 and process data received through uplink transmission performed on the basis of the radio resources by the electronic device 310.

According to various embodiments of the disclosure, when the LBT duration that can be identified by the electronic device 310 is received, the processor 321 may calculate a corrected TA value on the basis of the TA value of the electronic device 310 and the received LBT duration. According to various embodiments, the processor 321 may calculate the corrected TA value through Equation (1) above and transmit the calculated corrected TA value to the electronic device 310.

According to various embodiments of the disclosure, the processor 321 may receive the TA value corrected by the electronic device 310.

According to various embodiments of the disclosure, the processor 321 of the eNB 320 may check a sequence start region of the preamble allocated to the electronic device 310 which is added to the last region of the preamble included in the random-access preamble received from the electronic device 310 and identify how long the electronic device performs the LBT operation, that is, the LBT duration time. Further, the processor 321 may control the TA value set in accordance with the cell in which the electronic device is located 310, or may set the TA value of the electronic device on the basis of the identified LBT duration time. The processor 321 may perform control to transmit a response message including the controlled or set TA value to the electronic device 310.

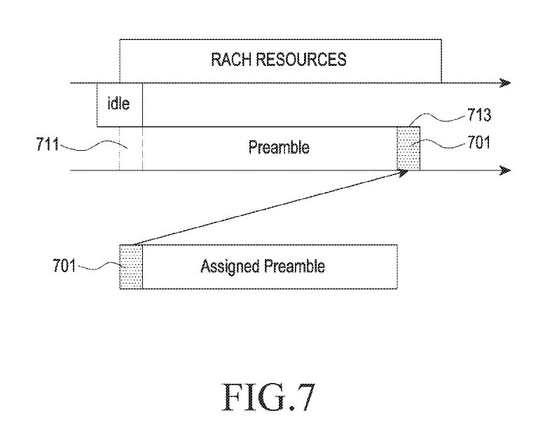

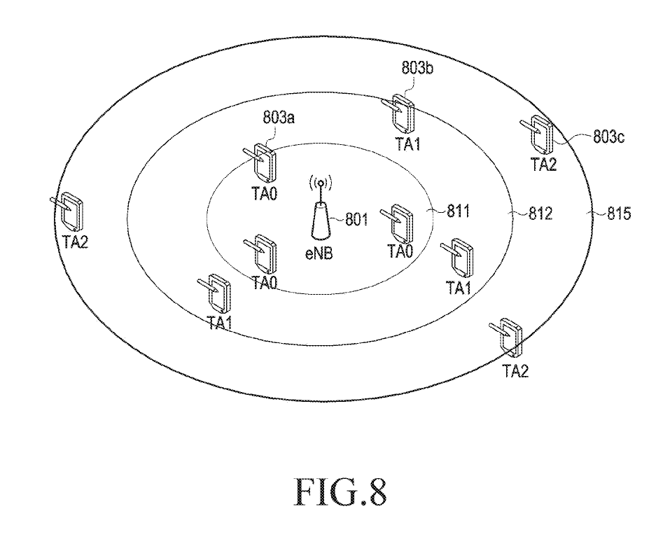

According to various embodiments of the disclosure, the processor 321 may group electronic devices having the same TA value on the basis of TA values set according to each unlicensed band cell. The eNB 320 may perform a scheduling operation using the grouping. Uplink transmission of electronic devices having the same TA value may be performed at the same time point. For example, the scheduling operation may be performed such that uplink transmission of electronic devices having TA0 of FIG. 8 and transmission of electronic devices having TA1 or TA2 are not performed simultaneously.

According to various embodiments, the processor 321 is a hardware module or a software module (for example, an application program) and may be a hardware element (function) or a software element (program) including at least one of various sensors included in the eNB 320, a data measurement module, an input/output interface, a module for managing a state or an environment of the eNB 320, or a communication module.

According to various embodiments of the disclosure, the transmission/reception device 323 of the eNB 320 is a communication module and may communicate with another electronic device (for example, the electronic device 102 or 104 of FIG. 1 or the server 106) over the wireless communication network according to the control of the processor 321. According to various embodiments of the disclosure, the communication module may transmit and receive data related to the operation executed according to the control of the processor 321 to and from other devices connected to the electronic device 310 or the network. The communication module may be connected to a network using wireless communication or wired communication via a communication interface, or may perform communication through device-to-device connection. The wireless communication may include at least one of, for example, Wireless Fidelity (Wi-Fi), Bluetooth (BT), ZigBee, Z-Wave, Near Field Communication (NFC), Global Positioning System (GPS), or cellular communication (for example, at least one of LTE, LTE-A, LTE-U, LAA, CDMA, WCDMA, UMTS, WiBro, or GSM). The wired communication may include at least one of, for example, a Universal Serial Bus (USB), a High-Definition Multimedia Interface (HDMI), Recommended Standard 232 (RS-232), a Plain Old Telephone Service (POTS), a Universal Asynchronous Receiver Transmitter (UART), an Inter-Integrated Circuit (I2C), a Serial Peripheral Interface (SPI), or a Controller Area Network (CAN). The communication module may include all types of communication schemes that have been widely known or are to be developed in the future, as well as the aforementioned communication schemes.

According to various embodiments of the disclosure, the memory 325 of the eNB 320 may temporarily store a program required for the functional operation according to various embodiments and various pieces of data generated during execution of the program. The memory 325 may broadly include a program area and a data area. The program area may store information related to driving, such as an Operating System (OS) for booting the eNB 320. Further, the memory 325 may include at least one storage medium of a flash memory, a hard disk, a multimedia card micro-type memory (for example, an SD or XD memory), RAM, and ROM. According to various embodiments, the memory 325 may store information for communication with the electronic device 310 and transmitted/received data.

According to various embodiments of the disclosure, not all of the elements of the eNB 320 illustrated in FIG. 3 are necessary elements, and the eNB 320 may be implemented as a larger number or a smaller number of elements than the illustrated elements. Further, the locations of the main elements of the eNB 320 illustrated in FIG. 3 may be changed according to various embodiments.

The electronic device in the wireless communication system according to one of the various embodiments of the disclosure may include a transmission/reception device for transmitting/receiving data and a processor for controlling the transmission/reception device, and the processor may perform control to transmit a random-access preamble to the eNB in an unlicensed band, acquire timing advance (TA) information in response to the random-access preamble, and control the acquired timing advance (TA) information so as to perform uplink transmission.

According to various embodiments of the disclosure, the processor may control the TA information based on the acquired TA information and the duration of the LBT operation of the electronic device.

According to various embodiments of the disclosure, the processor may perform control to transmit the controlled TA information to the eNB.

According to various embodiments of the disclosure, the processor may perform control to transmit the duration of the LBT operation to the eNB.

According to various embodiments of the disclosure, the random-access preamble is configured by cutting a region of a allocated preamble corresponding to the duration time of the LBT operation from the allocated preamble, and attaching the cut region to a last region of the allocated preamble.

According to various embodiments of the disclosure, the processor may perform the LBT operation before a preamble transmission interval designated by the eNB, and when it is determined that the preamble transmission interval is occupied, perform the LBT operation again in an interval corresponding to a next preamble transmission interval.

According to various embodiments of the disclosure, the processor may select a random-access preamble based on the acquired TA information and the duration of the LBT operation of the electronic device.

According to various embodiments of the disclosure, the processor may select one of a plurality of preamble groups based on the duration of the LBT operation, select one preamble belonging to the selected group, and transmit the selected preamble to the eNB.

According to various embodiments of the disclosure, the processor may identify an occupation state of a channel for uplink transmission, and when it is determined that the channel is occupied or used by another electronic device or another system, identify the occupation state of the channel again without transmitting a preamble.

Upon receiving an uplink grant signal from the eNB, the processor may identify scheduled radio resources in the uplink grant signal, control a band-pass filter on the basis of the frequency band of the identified radio resources, and determine whether to perform uplink transmission through the scheduled resources according to an LBT result in the band-pass filter.

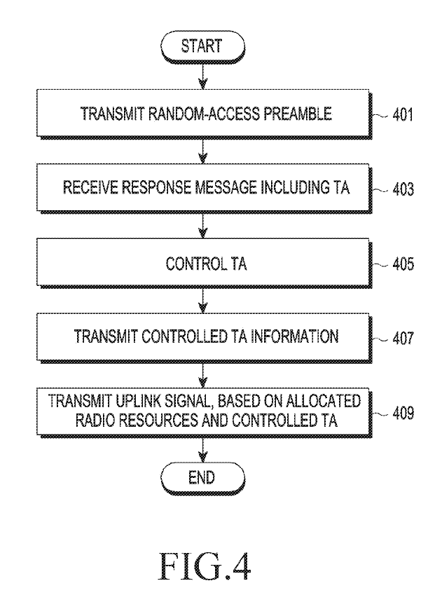

FIG. 4 illustrates an operation process of the electronic device according to various embodiments of the disclosure.

The electronic device (for example, the electronic device 101 of FIG. 1, the electronic device 203 of FIG. 2, or the electronic device 310 of FIG. 3) according to various embodiments of the disclosure may perform wireless communication with the eNB (for example, the same as or similar to the eNB 201 of FIG. 2 or the eNB 320 of FIG. 3) existing over the network through an unlicensed band. The electronic device 310 may perform an LBT operation as a preparation operation before performing uplink transmission in the unlicensed band and identify a channel occupation state through the LBT operation. According to various embodiments, when a channel for the selected frequency is occupied, the electronic device 310 may wait for a predetermined time and perform sensing again so as to select the corresponding channel.

Referring to FIG. 4, in operation 401, the electronic device according to various embodiments of the disclosure may transmit a random-access preamble message to the eNB on the basis of a RACH preamble allocated by the eNB. Further, according to various embodiments, the electronic device may transmit the random-access preamble message to the eNB on the basis of a RACH preamble selected using information that the electronic device knows. The random-access preamble message may include a selected preamble sequence.

In operation 403, the electronic device may receive a response message (for example, an RA response message) from the eNB in response to the random-access preamble message. The response message may include timing information (for example, a TA value) set in accordance with a second cell (SCell) in which the electronic device is located.

In operation 405, the electronic device may identify the timing information (TA value) included in the response message. The electronic device may correct the TA value received from the eNB 310 on the basis of the timing information (TA) and LBT duration time. The corrected TA value may be calculated through Equation (1).

In operation 407, the electronic device may transmit the corrected TA value to the eNB.

In operation 409, the electronic device may receive radio resources from the eNB and perform uplink transmission based on the allocated radio resources so as to transmit data to the eNB.

According to various embodiments of the disclosure, the electronic device may transmit the data to the eNB through an uplink transmission service in an unlicensed band.

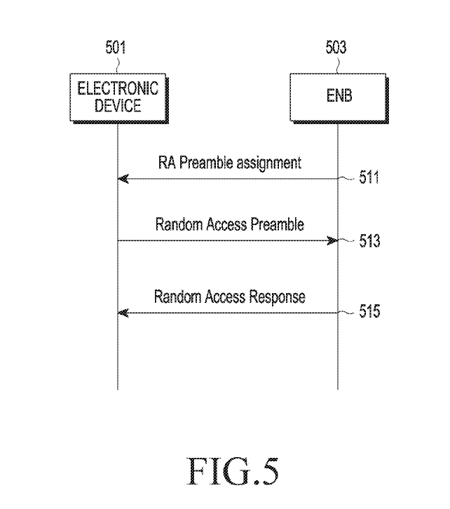

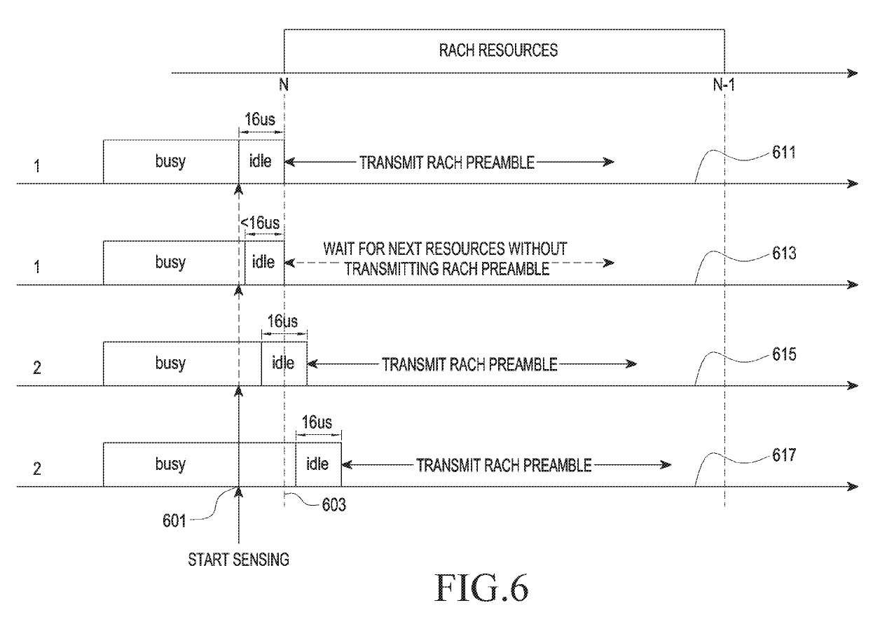

FIG. 5 illustrates a random-access operation process between the electronic device and the eNB according to various embodiments of the disclosure, and FIG. 6 illustrates an example of RACH preamble transmission of the electronic device according to various embodiments of the disclosure.

Referring to FIG. 5, an electronic device 501 (for example, the electronic device 101 of FIG. 1, the electronic device 203 of FIG. 2, or the electronic device 310 of FIG. 3) according to various embodiments of the disclosure may transmit and receive a message for a random-access operation to and from an eNB 503 (for example, the same as or similar to the eNB 201 of FIG. 2 or the eNB 320 of FIG. 3) existing over the network to perform wireless communication.

In operation 511, the electronic device 501 according to various embodiments of the disclosure may receive a random-access preamble allocation message from the eNB 503. The electronic device 501 may acquire preamble-allocation-related information included in the random-access (RA) preamble assignment message.

In operation 513, the electronic device 501 may identify the allocated RACH preamble on the basis of the preamble-assignment-related information and transmit a random-access preamble message including the allocated RACH preamble to the eNB 503 through designated RACH resources.

In operation 513, the electronic device 501 may receive a random-access response message in response to the random-access preamble message. The response message may include timing information (for example, the timing advance (TA) value) set in accordance with the distance between the electronic device 501 and the eNB 503 for the electronic device 501 in the RACH.

According to various embodiments, when the electronic device does not receive the response message from the eNB, the electronic device may transmit the random-access preamble message again in operation 513.

According to various embodiments, during the random access process or after the random access process, the electronic device 501 may transmit information related to access, transmit the corrected TA value, and/or further transmit/receive a message related to reception of information on contention termination.

According to various embodiments, the electronic device 501 may modify the preamble according to the LBT duration time during the random access process and transmit the modified preamble to the eNB 503.

Referring to FIG. 6, since the electronic device according to various embodiments of the disclosure performs the LBT operation during transmission of the random-access preamble, transmission of the RACH preamble may not be started from the boundary 603 of the designated RACH resources. That is, when transmission of the RACH preambles, such as transmission of partial preambles 615 and 617 of FIG. 6, starts after the boundary 603, the time point at which the eNB receives the RACH preamble may be influenced by a delay time due to LBT. The eNB may not exactly know which TA value should be transmitted to the electronic device. In order to prevent such a situation, the electronic device may wait for the next RACH resources without transmitting the RACH preamble, as indicated by reference numeral 613.

If the electronic device waits for the next RACH resources without transmitting the RACH preamble, as indicated by reference numeral 613, the delay may be large. If the RACH preamble remains during a time of an idle interval (for example, 16 us), the electronic device according to various embodiments of the disclosure may start transmission of the RACH preamble behind the RACH resource boundary 603. At this time, the aforementioned ambiguousness may occur. According to various embodiments of the disclosure, the electronic device may transmit the LBT duration time (for example, a value obtained by subtracting a time at a time point of the RACH resource boundary from a RACH preamble transmission start time) to the eNB, transmit a time point at which the actual RACH preamble is transmitted to the eNB, transmit the TA value obtained by correcting the TA value received from the eNB using the LBT duration which the electronic device knows, or control and transmit the RACH preamble.

FIG. 7 illustrates an operation process of the electronic device according to various embodiments of the disclosure.

Referring to FIG. 7, according to various embodiments of the disclosure, the electronic device (for example, the electronic device 101 of FIG. 1, the electronic device 203 of FIG. 2, or the electronic device 310 of FIG. 3) may receive RACH preambles from the eNB. After a signal detection time point (for example, the sensing timing time point 601 of FIG. 6) in a busy state, the electronic device may identify the LBT duration time, which is a waiting time for the LBT operation, cut a sequence 701 located in a start region 711 of the front preamble corresponding to the duration time identified in the allocated preamble, and attach the cut sequence to a last region 713 of the preamble.

According to various embodiments of the disclosure, the electronic device may transmit a random-access preamble message including the generated preamble to the eNB. Accordingly, when the eNB receives the random-access preamble message, the eNB may check the sequence start region 711 attached to the last region 713 of the preamble in the received preamble and identify how long the electronic device performs the LBT operation, that is, the LBT duration time. Further, the eNB may modify the TA value set in accordance with the cell in which the electronic device is located or set the TA value of the electronic device on the basis of the identified LBT duration time. Thereafter, the eNB may transmit a response message including the modified or set TA value to the electronic device.

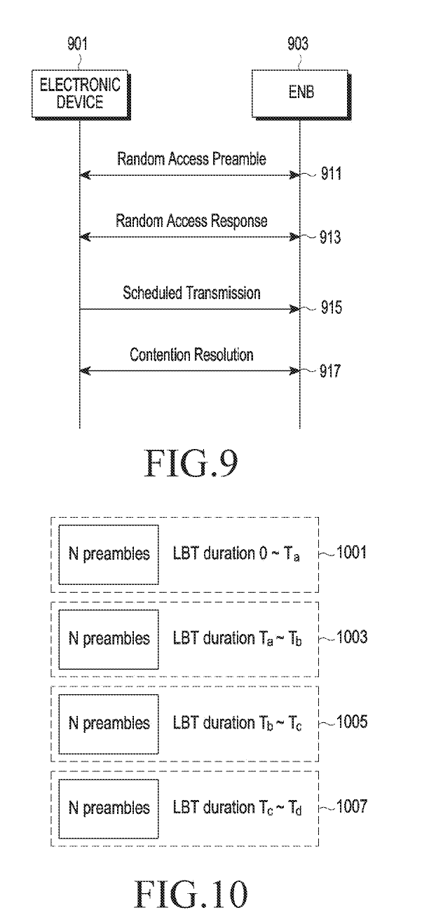

FIG. 8 illustrates grouping of electronic devices in a wireless communication system according to various embodiments of the disclosure, FIG. 9 illustrates an operation process between the electronic device and the eNB according to various embodiments of the disclosure, and FIG. 10 illustrates grouped preambles according to each LBT duration time according to various embodiments of the disclosure.

Referring to FIG. 8, an eNB 801 in a wireless communication system according to various embodiments of the disclosure may set different TA values according to the distances 811, 813, and 815 to electronic devices 803a, 803b, and 803c. The TA values set according to respective distances may increase as the distance from the electronic device becomes longer. The eNB 801 may group the electronic devices 803a, 803b, and 803c having equal TA values or similar TA values on the basis of the TA values set according to respective distances. The grouped electronic devices may be scheduled by a scheduler (not shown) of the eNB 801. For example, the scheduler may perform scheduling such that electronic devices that perform uplink transmission using the same time resources (for example, subframes, slots, and symbols) include only electronic devices belonging to the same group.

The electronic device in the wireless communication system according to various embodiments of the disclosure may select a RACH preamble. As illustrated in FIG. 10, the electronic device may select a preamble to be transmitted from among N preambles mapped according to each LBT duration time 1001, 1003, 1005, and 1007

Referring to FIG. 9, an electronic device 901 (for example, the electronic device 101 of FIG. 1, the electronic device 203 of FIG. 2, or the electronic device 310 of FIG. 3) according to various embodiments of the disclosure may perform a random access procedure with an eNB 903 (for example, the same as or similar to the eNB 201 of FIG. 2 or the eNB 320 of FIG. 3) existing over the network in order to perform wireless communication.

In operation 911, the electronic device 901 may select preamble groups 1001, 1003, 1005, and 1007 according to the LBT duration time and transmit a random-access preamble message containing preambles including a preamble selected from the corresponding preamble group to the eNB 903 according to various embodiments of the disclosure.

In operation 913, when the eNB 903 receives the random-access preamble message from the electronic device, the eNB 903 may transmit a response message to the electronic device 901. The eNB 903 may identify the LBT duration time on the basis of the preamble detected from the random-access preamble message and transmit the response message including a TA value set on the basis of the identified LBT duration time. Through processes 915 and 917, a contention resolution process may be performed.

The eNB may group electronic devices having the same TA value through the operation procedure according to embodiments of the disclosure as described above and perform uplink scheduling on the basis thereof. For example, electronic devices having the same TA value may be scheduled to perform Frequency-Division Multiplexing (FDM).

A method for wireless communication by an electronic device in a wireless communication system according to one of various embodiments of the disclosure may include an operation of transmitting a random-access preamble to an evolved Node B (eNB) in an unlicensed band, an operation of acquiring Timing Advance (TA) information in response to the random-access preamble, and an operation of transmitting the uplink data by controlling the acquired TA information.

According to various embodiments of the disclosure, the operation of controlling the received TA information during a random access process may further include an operation of correcting the TA information on the basis of the received TA information and the duration time of the frequency selection scheme (LBT) for identifying the channel occupation state of the electronic device and transmitting the duration time of the channel occupation state identification operation (LBT) operation to the eNB.

The method according to one of various embodiments of the disclosure may further include an operation of transmitting the controlled TA information to the eNB.

According to various embodiments of the disclosure, the random-access preamble is configured by cutting a region of a allocated preamble corresponding to the duration time of the LBT operation from the allocated preamble, and attaching the cut region to a last region of the allocated preamble.

The method according to one of various embodiments of the disclosure may further include an operation of performing the LBT operation before a preamble transmission interval designated by the eNB and an operation of, when it is determined that the preamble transmission interval is occupied, performing the LBT operation again in an interval corresponding to the next preamble transmission interval.

According to various embodiments of the disclosure, the operation of transmitting the random-access preamble to the eNB in the unlicensed band may include an operation of selecting the random-access preamble on the basis of the acquired TA information and the duration time of the LBT of the electronic device.

According to various embodiments, the operation of transmitting the random-access preamble to the eNB may include an operation of selecting at least one preamble group according to the duration time of the LBT, an operation of selecting at least one preamble from the preamble group, and an operation of transmitting the selected preamble to the eNB.

According to various embodiments of the disclosure, when the duration time of the LBT is larger than a predetermined reference value, the method may further include an operation of waiting for the next RACH resources without transmitting the preamble.

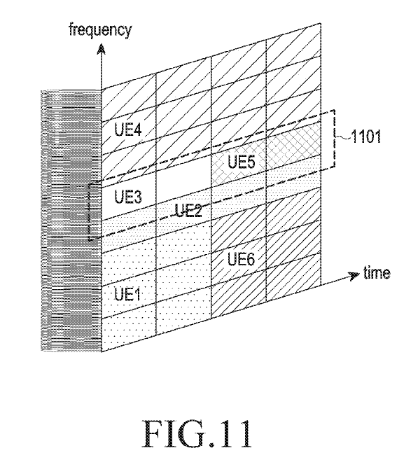

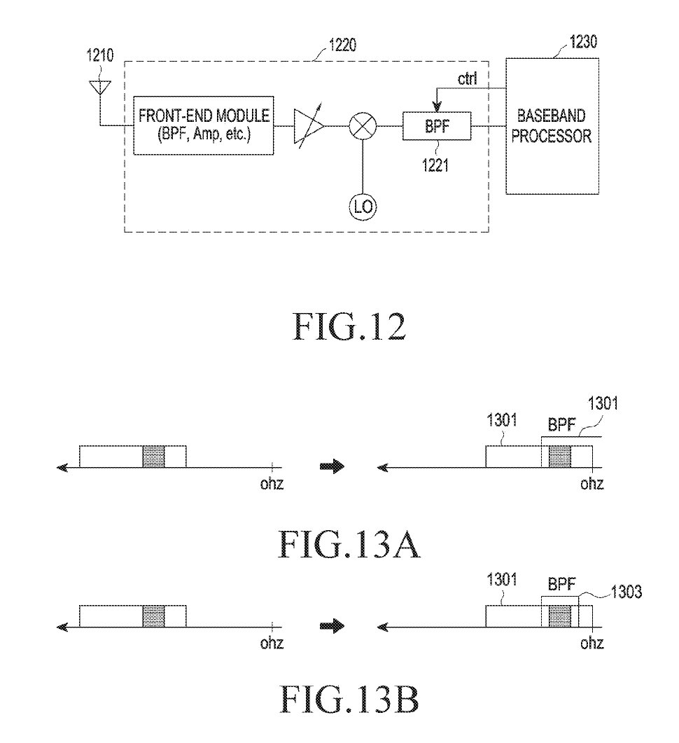

FIG. 11 illustrates a modulation scheme of a reception device of the electronic device according to various embodiments of the disclosure, and FIGS. 12 to 16 illustrate examples of the configuration of the electronic device according to various embodiments of the disclosure.

The electronic device according to various embodiments of the disclosure may include a transmission device and a reception device for uplink or downlink transmission. The transmission device and the reception device may include an end module (for example, a front-end module) for processing a signal transmitted/received through an antenna and a wireless processing module including modules for performing encryption or decryption of a transmitted/received signal, digital-analog conversion, noise removal, and a processor (for example, a baseband processor).

The reception device may further include a Band-Pass Filter (BPF). A modulation module of the electronic device may modulate data through various methods (for example, Orthogonal Frequency-Division Multiplexing (OFDM) and Single-Carrier Frequency-Division Multiple Access (SC-FDMA) and transmit the modulated data through uplink transmission. At this time, the electronic device may identify a pass band (for example, 1101) that the band-pass filter (BPF) allows to pass and determine uplink transmission according to the identification result. For example, when it is identified that the corresponding band is not used by another system or another electronic device on the basis of the identification result, uplink transmission can be performed. For example, when it is identified that the corresponding band is used by another system or another electronic device on the basis of the identification result, uplink transmission may not be performed. The band that the band-pass filter allows to pass therethrough may be determined by an uplink grant received by the electronic device. The band-pass filter may be set to allow at least some of the frequency domains included in the uplink grant or all of the frequency domains included in the uplink grant to pass therethrough.

The electronic device according to various embodiments of the disclosure may include band-pass filters 1221, 1421, 1521, or 1621 illustrated in FIGS. 12 to 16. The pass band filtered by the band-pass filter (BPF) may be filtered in units of a Physical Resource Block (PRB). The electronic device may determine the frequency band that the band-pass filter allows to pass therethrough based on the uplink grant received by the electronic device. The electronic device may select at least one PRB among the frequency bands included in the uplink grant as the pass band. The PRB is the smallest element among resources allocated according to eNB scheduling and may be defined as, for example, one resource block corresponding to 180 kHz in a frequency domain and including 12 carriers.

The electronic device illustrated in FIG. 12 and FIGS. 14 to 16 may include antennas 1210, 1410, 1510, and 1610, the wireless processing modules 1220, 1420, 1520, and 1620, and the baseband processors 1230, 1430, 1530, and 1630.

The reception device of the electronic device as illustrated in FIG. 12 may configure a narrow band-pass filter 1221 at the front end of the baseband processor 1230 so as to use a single filter in a time-division manner.

The baseband processor 1230 may determine the PRB to be used for uplink transmission in the uplink grant signal. According to various embodiments, the baseband processor 1230 may select one of the PRBs through which the BPF 1221 passes. The baseband processor 1230 may control the BPF 1221 or a Low-Pass Filter (LPF) to pass only the selected PRB. The baseband processor 1230 may transmit a control signal (ctl) to the BPF 1221 in order to perform control to pass the selected PRB. According to various embodiments, the baseband processor 1230 may determine a PRB location (for example, the frequency band 1101) to be used for UL transmission and transmit the control signal (ctl) to the BPF 1221 to pass only the corresponding PRB area (for example, the determined frequency band 1101).

As illustrated in FIGS. 13A and 13B, when the electronic device uses the LPF, the electronic device may down-convert a low frequency of the corresponding PRB region to become 0 Hz, that is, may control the LO itself or use a controller connected to the LO to control an amount of the down-converted frequency. If the block frequency of the LPF is controlled by the bandwidth 1301 of the PRB, the LPF may pass only the corresponding PRB region 1301. In the case in which the BPF 1221 is used, if down conversion suitable for a channel frequency is performed, the electronic device may pass only the PRB region 1303 by making the pass band of the BPF 1221 and the central frequency fit the PRB region 1303. The number of PRBs to be used for UL transmission may be one or more, and if one PRB is selected from among the plurality of PRBs, only a band of the corresponding selected PRB may be passed therethrough. The BPF 1221 may consist of two filter sets. If outermost PRBs are selected from among the plurality of PRBs, only bands corresponding to the selected PRBs may be passed through.

Accordingly, the electronic device may perform the LBT operation for the selected PRB through a scheme of performing energy detection in the pass band.

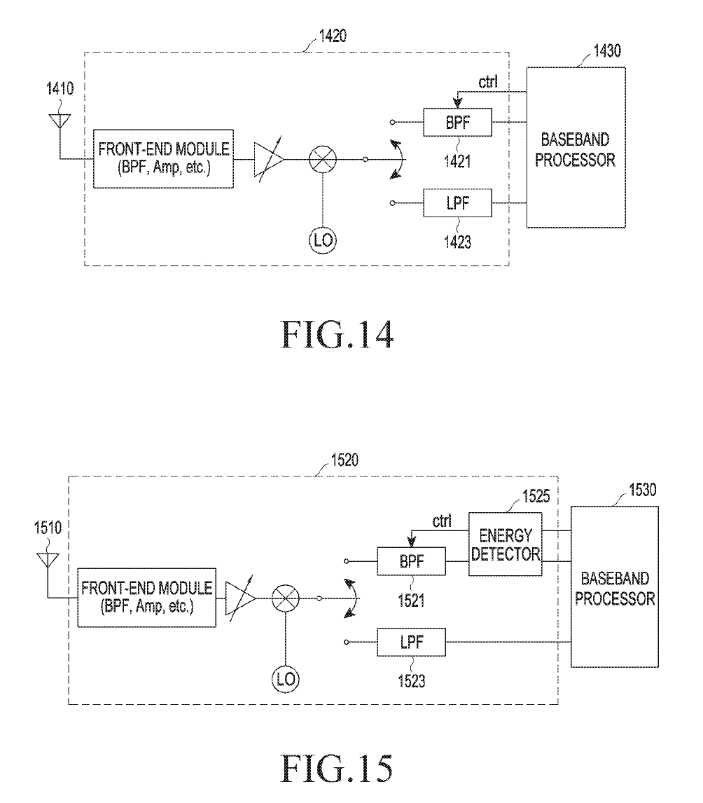

According to various embodiments of the disclosure, the electronic device may further include a BPF 1421 and a separate filter (for example, an LPF 1422), as illustrated in FIG. 14. A baseband processor 1430 of the electronic device may perform control to be connected to the conventional LPF 1422 in downlink transmission, and when an Uplink (UP) grant signal is received, may be connected to the BPF 1421 to perform the LBT operation for the pass band and perform the energy detection operation.

According to various embodiments of the disclosure, the electronic device may include a BPF 1521 and a separate filter (for example, an LPF 1522), as illustrated in FIG. 15, and an energy detector 1525 may be separately configured outside a baseband processor 1530. The baseband processor 1530 may provide an energy detection threshold to the energy detector 1525. The energy detector 1525 may operate according to the energy detection threshold provided by the baseband processor 1530. The BPF 1521 may be controlled by the energy detector 1525. At this time, the baseband processor 1530 may inform the energy detector 1525 of the location of the pass band. Further, the BPF 1521 may be controlled by the baseband processor 1530.

As described above, the embodiments illustrated in FIGS. 12, 14, and 15 are embodiments of implementing a narrow band-pass filter (BPF) in the baseband after down-conversion. The embodiments may be applied to a carrier frequency in a similar way.

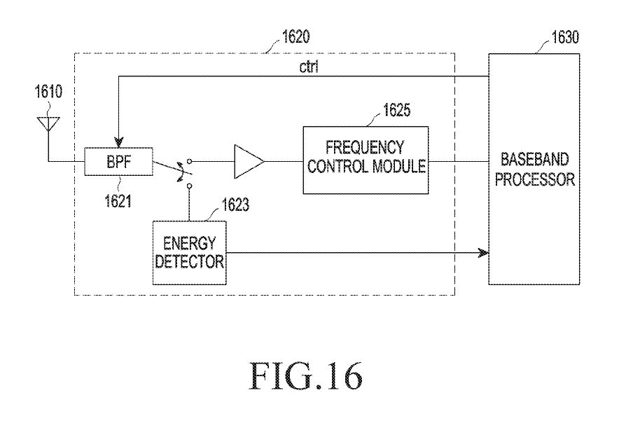

According to various embodiments of the disclosure, the electronic device may decode an uplink (UL) grant by a baseband processor 1630, as illustrated in FIG. 16. The baseband processor 1630 may extract a PRB used for UL transmission from decoded data, transmit a control signal (ctrl) for controlling a BPF 1621 on the basis of the extracted PRB, and monitor the output of the BPF 1621 through the energy detector 1623. The reception device may include a switch between the BPR 1621, an LNA, and the energy detector 1623.

As described above, the electronic device illustrated in FIGS. 12 to 16 can perform the LBT only in the scheduled band, that is, the pass band filtered by the BPF, and thus avoid interruption by other electronic devices when the operation for access to the eNB is performed.

An electronic device in a wireless communication system according to one of various embodiments of the disclosure may include a filter, a transmission/reception device for transmitting and receiving data, and a processor for controlling the transmission/reception device, and the processor may receive an uplink grant from the eNB and control the filter on the basis of the uplink grant.

According to various embodiments of the disclosure, the processor may extract the frequency resource region indicated by the received uplink grant and control the filter to pass the extracted frequency resource region. The filter may include at least one of a low band-pass filter (LPF) or a band-pass filter (BPF). A method for wireless communication by an electronic device in a wireless communication system according to one of various embodiments of the disclosure may include an operation of receiving an uplink grant from the eNB, and a filter included in a reception filter may be controlled on the basis of the uplink grant.

According to various embodiments of the disclosure, the method of controlling the filter included in the reception device of the electronic device on the basis of the uplink grant may include an operation of extracting a frequency resource region indicated by the uplink grant received from the eNB and an operation of controlling a filter to pass the extracted frequency resource region.

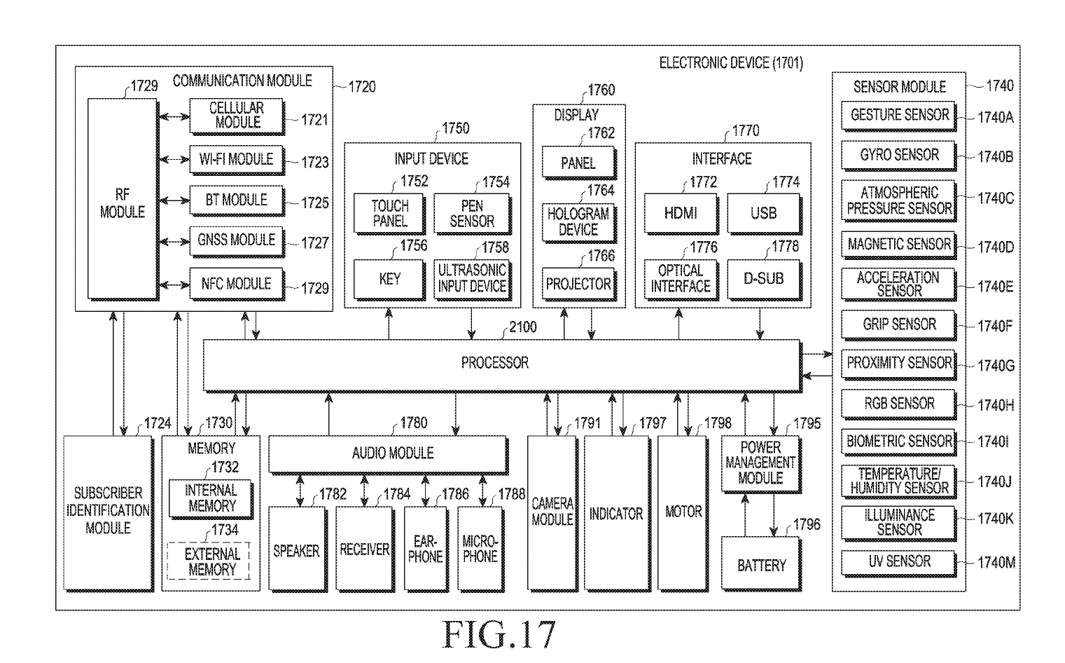

FIG. 17 is a block diagram of an electronic device according to various embodiments.

The electronic device 1801 may include, for example, the whole or part of the electronic device 101 illustrated in FIG. 1. The electronic device 1801 may include at least one processor 1810 (for example, an AP), a communication module 1820, a subscriber identification module 1824, a memory 1830, a sensor module 1840, an input device 1850, a display 1860, an interface 1870, an audio module 1880, a camera module 1891, a power management module 1895, a battery 1896, an indicator 1897, and a motor 1898. The processor 1810 may control a plurality of hardware or software elements connected thereto and may perform various data processing and operations by driving an operating system or an application program. The processor 1810 may be implemented by, for example, a System on Chip (SoC). According to an embodiment, the processor 1810 may further include a graphic processing unit (GPU) and/or an image signal processor. The processor 1810 may also include at least some of the elements illustrated in FIG. 17 (for example, a cellular module 1821). The processor 1810 may load, in volatile memory, instructions or data received from at least one of the other elements (for example, non-volatile memory), process the loaded instructions or data, and store the resultant data in the non-volatile memory.

The communication module 1820 may have a configuration that is the same as, or similar to, that of the communication interface 170. The communication module 1820 (for example, the communication interface 170) may include, for example, a cellular module 1821, a Wi-Fi module 1823, a Bluetooth module 1825, a GNSS module 1827, an NFC module 1828, and an RF module 1829. The cellular module 1821 may provide, for example, a voice call, a video call, a text-message service, an Internet service, or the like via a communication network. According to an embodiment, the cellular module 1821 may identify and authenticate the electronic device 1801 within a communication network using the subscriber identification module 1824 (for example, a SIM card). According to an embodiment, the cellular module 1821 may perform at least some of the functions that the processor 1810 may provide. According to an embodiment, the cellular module 1821 may include a communication processor (CP). According to some embodiments, at least some (for example, two or more) of the cellular module 1821, the Wi-Fi module 1823, the BT module 1825, the GNSS module 1827, or the NFC module 1828 may be included in one Integrated Chip (IC) or IC package. The RF module 1829 may transmit/receive, for example, a communication signal (for example, an RF signal). The RF module 1829 may include, for example, a transceiver, a power amp module (PAM), a frequency filter, a low noise amplifier (LNA), an antenna, or the like. According to another embodiment, at least one of the cellular module 1821, the Wi-Fi module 1823, the BT module 1825, the GNSS module 1827, or the NFC module 1828 may transmit and receive RF signals through a separate RF module. The subscriber identification module 1824 may include, for example, a card that includes a subscriber identity module or an embedded SIM, and may contain unique identification information (for example, an Integrated Circuit Card Identifier (ICCID)) or subscriber information (for example, an International Mobile Subscriber Identity (IMSI)).

The memory 1830 (for example, the memory 130) may include, for example, an internal memory 1832 or an external memory 1834. The internal memory 1832 may include, for example, at least one of a volatile memory (for example, a DRAM, an SRAM, an SDRAM, or the like), a non-volatile memory (for example, a One Time Programmable ROM (OTPROM), a PROM, an EPROM, an EEPROM, a mask ROM, a flash ROM, a flash memory, a hard disc drive, or a Solid State Drive (SSD)). The external memory 1834 may include a flash drive, for example, a compact flash (CF), a secure digital (SD), a Micro-SD, a Mini-SD, an eXtreme digital (xD), a multi-media card (MMC), a memory stick, or the like. The external memory 1834 may be functionally or physically connected to the electronic device 1801 through various interfaces.

The sensor module 1840 may, for example, measure a physical quantity or detect the operating state of the electronic device 1801 and may convert the measured or detected information into an electrical signal. The sensor module 1840 may include, for example, at least one of a gesture sensor 1840A, a gyro sensor 1840B, an atmospheric pressure sensor 1840C, a magnetic sensor 1840D, an acceleration sensor 1840E, a grip sensor 1840F, a proximity sensor 1840G, a color sensor 1840H (for example, a Red, Green, and Blue (RGB) sensor), a biometric sensor 1840I, a temperature/humidity sensor 1840J, an illumination sensor 1840K, or a ultraviolet (UV) sensor 1840M. Additionally or alternatively, the sensor module 1840 may include, for example, an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1840 may further include a control circuit for controlling one or more sensors included therein. In some embodiments, the electronic device 1801 may further include a processor configured to control the sensor module 1840 as a part of or separately from the AP 1810, and may control the sensor module 1840 while the AP 1810 is in a sleep state.

The input device 1850 may include, for example, a touch panel 1852, a (digital) pen sensor 1854, a key 1856, or an ultrasonic input device 1858. The touch panel 1852 may use, for example, at least one of a capacitive type, a resistive type, an infrared type, and an ultrasonic type. Furthermore, the touch panel 1852 may further include a control circuit. The touch panel 1852 may further include a tactile layer to provide a tactile reaction to a user. The (digital) pen sensor 1854 may include, for example, a recognition sheet that is a part of, or separate from, the touch panel. The key 1856 may include, for example, a physical button, an optical key, or a keypad. The ultrasonic input device 1858 may detect ultrasonic waves, which are generated by an input tool, through a microphone (for example, a microphone 1888) to identify data corresponding to the detected ultrasonic waves.

The display 1860 (for example, the display 160) may include a panel 1862, a hologram device 1864, a projector 1866, and/or a control circuit for controlling them. The panel 1862 may be implemented to be, for example, flexible, transparent, or wearable. The panel 1862, together with the touch panel 1852, may be configured as one or more modules. According to an embodiment, the panel 1862 may include a pressure sensor (or a POS sensor) which may measure a strength of pressure of a user's touch. The pressure sensor may be implemented so as to be integrated with the touch panel 1852 or may be implemented as one or more sensors separate from the touch panel 1852. The hologram device 1864 may show a three dimensional image in the air by using an interference of light. The projector 1866 may display an image by projecting light onto a screen. The screen may be located, for example, in the interior of, or on the exterior of, the electronic device 1801. The interface 1870 may include, for example, an HDMI 1872, a USB 1874, an optical interface 1876, or a D-subminiature (D-sub) 1878. The interface 1870 may be included in, for example, the communication circuit 170 illustrated in FIG. 1. Additionally or alternatively, the interface 1870 may, for example, include a mobile high-definition link (MHL) interface, a secure digital (SD) card/multi-media card (MMC) interface, or an infrared data association (IrDA) standard interface.

The audio module 1880 may convert, for example, sound into an electrical signal, and vice versa. At least some elements of the audio module 1880 may be included, for example, in the input/output interface 145 illustrated in FIG. 1. The audio module 1880 may process sound information that is input or output through, for example, a speaker 1882, a receiver 1884, earphones 1886, or the microphone 1888, and the like. The camera module 1831 is a device that can photograph a still image and a moving image. According to an embodiment, the camera module 291 may include one or more image sensors (for example, a front sensor or a rear sensor), a lens, an image signal processor (ISP), or a flash (for example, an LED or xenon lamp). The power management module 1895 may manage, for example, the power of the electronic device 1801. According to an embodiment, the power management module 1895 may include a power management integrated circuit (PMIC), a charger IC, or a battery or fuel gauge. The PMIC may use a wired and/or wireless charging method. Examples of the wireless charging method may include a magnetic resonance method, a magnetic induction method, an electromagnetic wave method, or the like. Additional circuits (for example, a coil loop, a resonance circuit, a rectifier, or the like) for wireless charging may be further included. The battery gauge may measure, for example, the residual amount of the battery 1896 and a voltage, current, or temperature while charging. The battery 1896 may include, for example, a rechargeable battery and/or a solar battery.

The indicator 1897 may display a particular state, for example, a booting state, a message state, a charging state, or the like of the electronic device 1801 or a part (for example, the processor 1810) of the electronic device 201. The motor 1898 may convert an electrical signal into a mechanical vibration and may generate a vibration, a haptic effect, or the like. The electronic device 1801 may include a mobile TV support device that can process media data according to a standard, such as digital multimedia broadcasting (DMB), digital video broadcasting (DVB), MediaFLO™, or the like. Each of the above-described component elements of hardware according to the disclosure may be configured with one or more components, and the names of the corresponding component elements may vary based on the type of electronic device. In various embodiments, an electronic device (for example, the electronic device 1801) may omit some elements or may further include additional elements, or some of the elements of the electronic device may be combined with each other to configure one entity, in which case the electronic device may identically perform the functions of the corresponding elements prior to the combination.

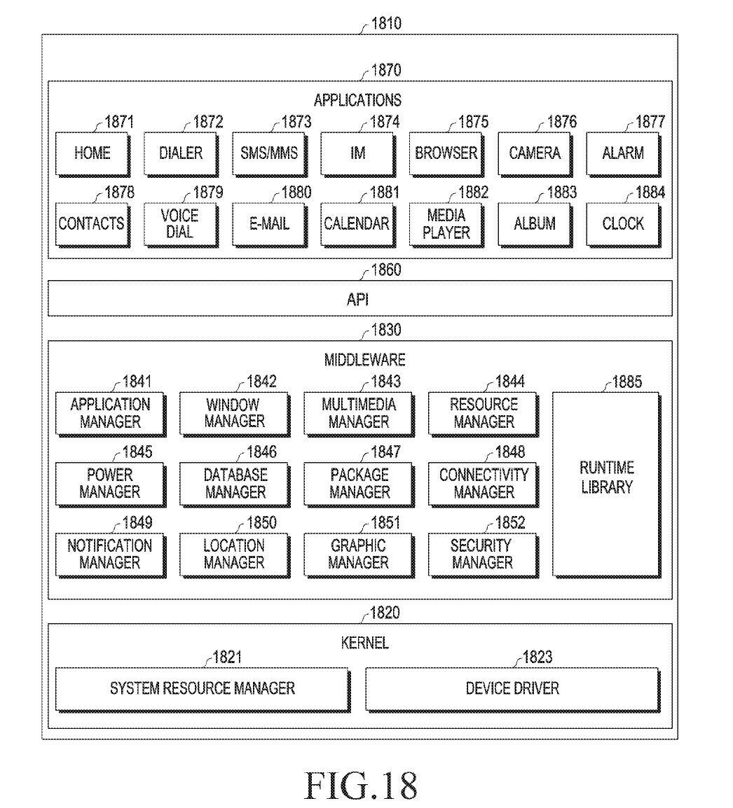

FIG. 18 is a block diagram of a program module according to various embodiments.

According to an embodiment, the program module 1910 (for example, the program 140) may include an Operating System (OS) that controls resources relating to an electronic device (for example, the electronic device 101) and/or various applications (for example, the application programs 147) that are driven on the operating system. The operating system may include, for example, Android™, iOS™, Windows™, Symbian™, Tizen™, or Bada™. Referring to FIG. 18, the program module 1910 may include a kernel 1920 (for example, the kernel 141), middleware 1930 (for example, the middleware 143), an API 1960 (for example, the API 145), and/or applications 1970 (for example, the application programs 147). At least a part of the program module 1910 may be preloaded on the electronic device, or may be downloaded from an external electronic device (for example, the electronic device 102 or 104 or the server 106).

The kernel 1920 may include, for example, a system resource manager 1921 and/or a device driver 1923. The system resource manager 1921 may control, allocate, or retrieve system resources. According to an embodiment, the system resource manager 1921 may include a process manager, a memory manager, or a file system manager. The device driver 1923 may include, for example, a display driver, a camera driver, a Bluetooth driver, a shared memory driver, a USB driver, a keypad driver, a Wi-Fi driver, an audio driver, or an Inter-Process Communication (IPC) driver. The middleware 1930 may provide a function required by the applications 1970 in common or provide various functions to the applications 1970 through the API 1960 so that the applications 1970 can efficiently use limited system resources within the electronic device. According to an embodiment, the middleware 1930 may include at least one of a runtime library 1935, an application manager 1941, a window manager 1942, a multi-media manager 1943, a resource manager 1944, a power manager 1945, a database manager 1946, a package manager 1947, a connectivity manager 1948, a notification manager 1949, a location manager 1950, a graphic manager 1951, or a security manager 1952.

The runtime library 1935 may include, for example, a library module that a compiler uses in order to add a new function through a programming language while the applications 1970 are being executed. The runtime library 1935 may manage an input/output, manage a memory, or process an arithmetic function. The application manager 1941 may manage, for example, the life cycles of the applications 1970. The window manager 1942 may manage GUI resources used for a screen. The multimedia manager 1943 may identify formats required for reproducing various media files and may encode or decode a media file using a codec suitable for the corresponding format. The resource manager 1944 may manage the source code of the applications 1970 or the space in memory. The power manager 1945 may manage, for example, the capacity or power of a battery and may provide power information required for operating the electronic device. According to an embodiment, the power manager 1945 may operate in conjunction with a basic input/output system (BIOS). The database manager 1946 may, for example, generate, search, or change databases to be used by the applications 1970. The package manager 1947 may manage the installation or update of an application that is distributed in the form of a package file.

The connectivity manager 1948 may manage, for example, a wireless connection. The notification manager 1949 may provide information on an event (for example, an arrival message, an appointment, a proximity notification, or the like) to a user. The location manager 1950 may manage, for example, the location information of the electronic device. The graphic manager 1951 may manage a graphic effect to be provided to a user and a user interface relating to the graphic effect. The security manager 1952 may provide, for example, system security or user authentication. According to an embodiment, the middleware 1930 may include a telephony manager for managing a voice or video call function of the electronic device or a middleware module that is capable of forming a combination of the functions of the above-described elements. According to an embodiment, the middleware 1930 may provide specialized modules according to the types of operation systems. Furthermore, the middleware 1930 may dynamically remove some of the existing elements, or may add new elements. The API 1960 is, for example, a set of API programming functions, and may be provided with different configurations depending on the operating system. For example, in the case of Android or iOS, one API set may be provided for each platform, and in the case of Tizen, two or more API sets may be provided for each platform.

The applications 1970 may include, for example, a home application 1971, a dialer application 1972, an SMS/MMS application 1973, an instant messaging (IM) application 1974, a browser application 1975, a camera application 1976, an alarm application 1977, a contact application 1978, a voice dial application 1979, an email application 1980, a calendar application 1981, a media player application 1982, an album application 1983, a watch application 1984, a health-care application (for example, for measuring exercise quantity or blood glucose), or an application providing environmental information (for example, atmospheric pressure, humidity, or temperature information). According to an embodiment, the applications 1970 may include an information exchange application that can support the exchange of information between the electronic device and an external electronic device. The information exchange application may include, for example, a notification relay application for relaying particular information to an external electronic device or a device management application for managing an external electronic device. For example, the notification relay application may relay notification information generated in the other applications of the electronic device to an external electronic device, or may receive notification information from an external electronic device to provide the received notification information to a user. The device management application may install, delete, or update functions of an external electronic device that communicates with the electronic device (for example, turning on/off the external electronic device itself (or some elements thereof) or adjusting the brightness (or resolution) of a display) or applications executed in the external electronic device. According to an embodiment, the applications 1970 may include applications (for example, a health care application of a mobile medical appliance) that are designated according to the attributes of an external electronic device. According to an embodiment, the applications 1970 may include applications received from an external electronic device. At least some of the program module 1910 may be implemented (for example, executed) by software, firmware, hardware (for example, the processor 210), or a combination of two or more thereof and may include a module, a program, a routine, an instruction set, or a process for performing one or more functions.

The term “module” as used herein may include a unit consisting of hardware, software, or firmware, and may, for example, be used interchangeably with the term “logic”, “logical block”, “component”, “circuit”, or the like. The “module” may be an integrated component, or a minimum unit for performing one or more functions or a part thereof. The “module” may be mechanically or electronically implemented and may include, for example, an Application-Specific Integrated Circuit (ASIC) chip, a Field-Programmable Gate Arrays (FPGA), or a programmable-logic device, which has been known or is to be developed in the future, for performing certain operations. At least some of the devices (e.g., modules or functions thereof) or methods (e.g., operations) according to various embodiments may be implemented by an instruction which is stored in a computer-readable storage medium (e.g., the memory 140) in the form of a program module. The instruction, when executed by a processor (e.g., the processor 120), may cause the one or more processors to execute the function corresponding to the instruction. The computer-readable storage medium may include a hard disk, a floppy disk, a magnetic medium (e.g., a magnetic tape), an Optical Media (e.g., CD-ROM, DVD), a Magneto-Optical Media (e.g., a floptical disk), an inner memory, etc. The instruction may include a code made by a complier or a code that can be executed by an interpreter. The programming module according to the disclosure may include one or more of the aforementioned components or may further include other additional components, or some of the aforementioned components may be omitted. The operations performed by modules, programming modules, or other elements according to various embodiments may be performed in a sequential, parallel, repetitive, or heuristic manner, some of the operations may be performed in different orders or omitted, or other operations may be added.

According to various embodiments, a computer-readable recording medium having a program recorded therein to be executed in a computer is provided. The program may cause, when executed by a processor, the processor to perform an operation of transmitting a random-access preamble to an eNB in an unlicensed band, an operation of acquiring Time Advance (TA) information in response to the random-access preamble, and an operation of transmitting uplink data by controlling the acquired TA information.

Various embodiments disclosed herein are provided merely to easily describe technical details of the disclosure and to help the understanding of the disclosure, and are not intended to limit the scope of the disclosure. Therefore, it should be construed that all modifications and changes or modified and changed forms based on the technical idea of the disclosure fall within the scope of the disclosure.

1. An electronic device in a wireless communication system, the electronic device comprising:
a transmission/reception device configured to transmit and receive data; and
a processor configured to control the transmission/reception device,
wherein the processor is configured to:
control to transmit a random-access preamble to an evolved Node B (eNB) in an unlicensed band,
acquire Timing Advance (TA) information in response to the random-access preamble, and
perform uplink transmission by controlling the acquired TA information.

2. The electronic device of claim 1, wherein the processor is further configured to control the TA information, based on the acquired TA information and a duration time of a channel occupation state identification operation (LBT) of the electronic device.

3. The electronic device of claim 1, wherein the processor is further configured to control to transmit the controlled TA information to the eNB.

4. The electronic device of claim 2, wherein the processor is further configured to control to transmit the duration time of the LBT operation to the eNB.

5. The electronic device of claim 2, wherein the random-access preamble is configured by cutting a region of a allocated preamble corresponding to the duration time of the LBT operation from the allocated preamble, and attaching the cut region to a last region of the allocated preamble.

6. The electronic device of claim 2, wherein the processor is further configured to:
perform the LBT operation before a preamble transmission interval designated by the eNB, and
when it is determined that the preamble transmission interval is occupied, perform the LBT operation again in an interval corresponding to a next preamble transmission interval.

7. The electronic device of claim 1, wherein the processor is further configured to select a random-access preamble, based on the acquired TA information and the duration time of the LBT operation of the electronic device.

8. An electronic device in a wireless communication system, the electronic device comprising:
a filter;
a transmission/reception device configured to transmit and receive data; and
a processor configured to control the transmission/reception device,
wherein the processor is configured to:
receive an uplink grant from an evolved Node B (eNB), and
control the filter, based on the uplink grant.

9. The electronic device of claim 8, wherein the processor is further configured to:
extract a frequency resource region indicated by the received uplink grant, and
control the filter to pass the extracted frequency resource region.

10. The electronic device of claim 8, wherein the filter includes at least one of a low band-pass filter (LPF) or a band-pass filter (BPF).

11. A method for wireless communication by an electronic device in a wireless communication system, the method comprising:
transmitting a random-access preamble to an evolved Node B (eNB) in an unlicensed band;
acquiring Timing Advance (TA) information in response to the random-access preamble; and
transmitting the uplink data by controlling the acquired TA information.

12. The method of claim 11, further comprising:
controlling the TA information, based on the acquired TA information and a duration time of a channel occupation state identification operation (LBT) of the electronic device;
performing the LBT operation before a preamble transmission interval designated by the eNB; and
upon determining that the preamble transmission interval is occupied, performing the LBT operation again in an interval corresponding to a next preamble transmission interval.

13. The method of claim 11, wherein the random-access preamble is configured by cutting a region of a allocated preamble corresponding to the duration time of the LBT operation from the allocated preamble, and attaching attach the cut region to a last region of the allocated preamble.

14. A method for wireless communication by an electronic device in a wireless communication system, the method comprising:
receiving an uplink grant from an evolved Node B (eNB); and
controlling a filter included in a reception device of the electronic device, based on the uplink grant.

15. The method of claim 14, wherein the controlling of the filter included in the reception device of the electronic device, based on the uplink grant comprises:
extracting a frequency resource region indicated by the uplink grant received from the eNB; and
controlling the filter to pass the extracted frequency resource region.
